(19) United States
(12) Patent Application Publication
(10) Pub. No.: US 2009/0310202 A1
(43) Pub. Date: Dec. 17, 2009

(54) TILT MIRROR

(75) Inventors: Ki-Suk Woo, Seoul (KR); Hee-Yeoun Kim, Yongin-si (KR); Seung-Do An, Suwon-si (KR); Jong-Hyeong Song, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/471,272

(22) Filed: May 22, 2009

(30) Foreign Application Priority Data
Jun. 17, 2008 (KR) 10-2008-0057047

(51) Int. Cl. G02B 26/08

(52) U.S. Cl. 359/221.2; 359/224.1; 359/224.2

(57) ABSTRACT

A tilt mirror is disclosed. The tilt mirror can include: a reflection portion, which may reflect incident light; a first cantilever, which may be formed on either end of the reflection portion, and which may generate a stress in one direction; a second cantilever, which may be formed on either end of the reflection portion beside the first cantilever, and which may generate a stress in the other direction; and a connector portion, which may connect the reflection portion with one end of the first cantilever and with one end of the second cantilever such that the stress generated in the one direction and the stress generated in the other direction are transferred to the reflection portion. The tilt mirror provides a simple composition that can be utilized to alter the path for rays of light.

### CROSS-REFERENCE TO RELATED APPLICATIONS

This application claims the benefit of Korean Patent Application No. 10-2008-0057047 filed with the Korean Intellectual Property Office on Jun. 17, 2008, the disclosure of which is incorporated herein by reference in its entirety.

### BACKGROUND

1. Technical Field

The present invention relates to a tilt mirror, more particularly to tilt mirror applicable to an optical modulator.

2. Description of the Related Art

MEMS refers to a microelectromechanical system or element, which is a technology that uses semiconductor manufacturing technology to form three-dimensional structures on silicon substrates. There are a variety of applications in which MEMS is used, an example of which is the field of optics. Using MEMS technology allows the manufacture of optical components smaller than 1 mm, which can be used to implement micro-optical systems. Micro-optical components, such as optical modulators and micro-lenses, etc., may be selected for application in telecommunication devices, displays, and recording devices, due to such advantages as quick response time, low level of loss, and convenience in integrating and digitalizing.

Among the various optical components using MEMS technology, micromirrors may be employed to reflect light, and thereby either alter or block the light path. For example, in the case of a dynamic optical gain compensator, it is possible to use a prism or a diffraction grating to divert the light emitted from a light source to move in a particular angle to the direction of incidence, or to attenuate or eliminate components of the light in certain wavelengths using optical interference. In addition, an optical scanner may include a mirror capable of changing the angle, whereby the path of the outputted light may be altered according to the change in mirror angle.

An optical modulator may modulate incident light to form an image. To be more specific, the incident light may be modulated and outputted by numerous mirrors included in the optical modulator, so that consequently, an image may be displayed. A description will be provided as follows, with reference to FIG. 1, on the structure of a conventional optical modulator. FIG. 1 is a schematic diagram illustrating the structure of a conventional optical modulator.

A conventional optical modulator 100 may include a multiple number of micromirrors 110. Incident light entering the optical modulator 100 may be reflected and/or diffracted by the many micromirrors 110 to be outputted as modulated light 130. Here, light from the light source may also enter the areas 120 where there are no micromirrors 110 formed, so that unwanted strips may be displayed in portions above/below the image. That is, the incident light entering the areas 120 where the micromirrors 110 are not formed may be projected as spill light 140, to be displayed as undesired image strips.

### SUMMARY

An aspect of the invention provides a tilt mirror that can reflect light and thus alter the path of the light using MEMS technology.

Another aspect of the invention provides an optical modulator that can remove undesired noise from an image using the tilt mirror.

Still another aspect of the invention provides a tilt mirror that includes: a reflection portion, which may reflect incident light; a first cantilever, which may be formed on either end of the reflection portion, and which may generate a stress in one direction; a second cantilever, which may be formed on either end of the reflection portion beside the first cantilever, and which may generate a stress in the other direction; and a connector portion, which may connect the reflection portion with one end of the first cantilever and with one end of the second cantilever such that the stress generated in the one direction and the stress generated in the other direction are transferred to the reflection portion.

The tilt mirror can further include a support portion, which may support the other end of the first cantilever and the other end of the second cantilever. The stress in the one direction may be a tensile stress, while the stress in the other direction may be a compressive stress.

Also, at least one of the first cantilever and the second cantilever can include an actuator, which may modify the magnitude of the stress, wherein the actuator can include: two electrodes and a piezoelectric layer interposed between the two electrodes that is made from a piezoelectric material to contract or expand according to an operating voltage delivered to the two electrodes.

Here, the first cantilever may be a structure that includes SiNₓ, silicon dioxide (SiO₂), platinum (Pt), PZT, and platinum (Pt) stacked in order, or the second cantilever may be a structure that includes SiNₓ and silicon dioxide (SiO₂) stacked in order.

A low-reflective coating can be applied to one surface of the reflection portion that receives incident light from a light source, and the reflection portion can be configured to tilt from an initial position by an angle greater than or equal to 0.5 degrees and smaller than or equal to 10 degrees.

Yet another aspect of the invention provides an optical modulator that includes: a substrate; multiple ribbons, which may be formed in an actual area of the substrate in positions separated from the substrate by a predetermined distance, and which may be operated in accordance to a delivered voltage to modulate and output the incident light received from a light source; and multiple tilt mirrors formed in a dummy area of the substrate. Here, a tilt mirror can include: a reflection portion, which may reflect incident light; a first cantilever, which may be formed on either end of the reflection portion, and which may generate a stress in one direction; a second cantilever, which may be formed on either end of the reflection portion beside the first cantilever, and which may generate a stress in the other direction; and a connector portion, which may connect the reflection portion with one end of the first cantilever and with one end of the second cantilever such that the stress generated in the one direction and the stress generated in the other direction are transferred to the reflection portion. The actual area may be an area needed for forming an image, and the dummy area may be an area not needed for forming an image.

The tilt mirror can further include a support portion, which may support the other end of the first cantilever and the other end of the second cantilever. The stress in the one direction may be a tensile stress, while the stress in the other direction may be a compressive stress.

Also, at least one of the first cantilever and the second cantilever can include an actuator, which may modify the magnitude of the stress, wherein the actuator can include: two electrodes and a piezoelectric layer interposed between the two electrodes that is made from a piezoelectric material to contract or expand according to an operating voltage delivered to the two electrodes.

Here, the first cantilever may be a structure that includes SiNₓ, silicon dioxide (SiO₂), platinum (Pt), PZT, and platinum (Pt) stacked in order, or the second cantilever may be a structure that includes SiNₓ and silicon dioxide (SiO₂) stacked in order.

A low-reflective coating can be applied to one surface of the reflection portion that receives incident light from a light source, and the reflection portion can be configured to tilt from an initial position by an angle greater than or equal to 0.5 degrees and smaller than or equal to 10 degrees.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a schematic diagram illustrating the structure of a conventional optical modulator.

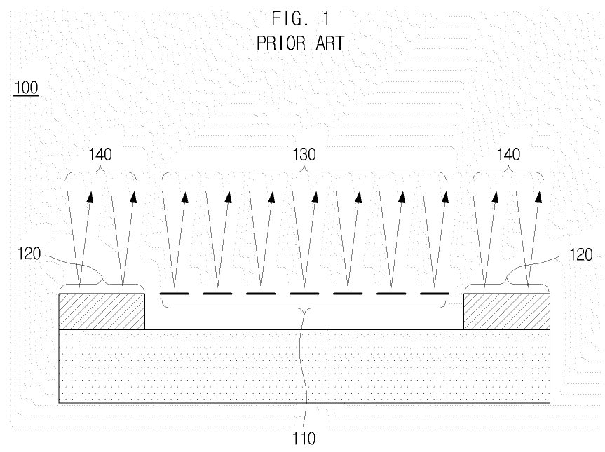

FIG. 2 is a diagram illustrating the structure of a tilt mirror according to an embodiment of the invention.

FIG. 3 is a diagram illustrating the structures of the first and second cantilevers on a tilt mirror according to an embodiment of the invention.

FIG. 4 is a diagram illustrating the structure of an optical modulator according to an embodiment of the invention.

FIG. 5 is a plan view of an optical modulator according to an embodiment of the invention.

FIG. 6 is a diagram illustrating a tilt mirror according to an embodiment of the invention in a tilted state.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various elements, such elements must not be limited to the above terms. The above terms are used only to distinguish one element from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added.

Certain embodiments of the invention will be described below in more detail with reference to the accompanying drawings. Those elements that are the same or are in correspondence are rendered the same reference numeral regardless of the figure number, and redundant explanations are omitted.

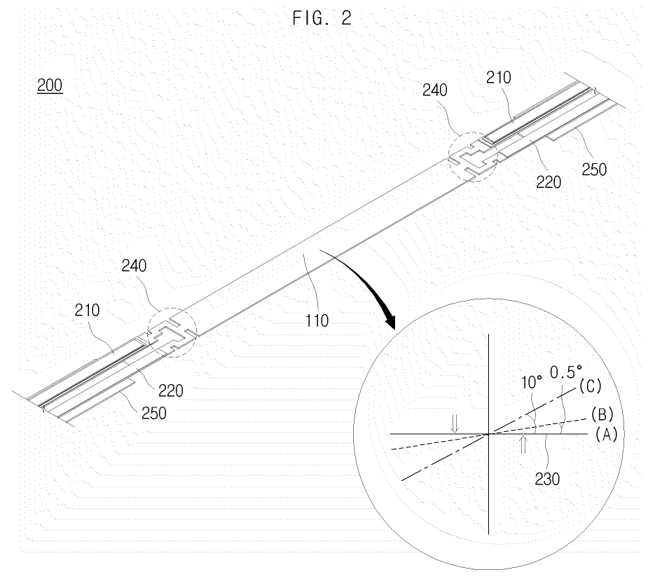

A description will be provided as follows, with reference to FIG. 2, on the structure of a tilt mirror according to an embodiment of the invention. FIG. 2 is a diagram illustrating the structure of a tilt mirror according to an embodiment of the invention.

A tilt mirror 200 according to an embodiment of the invention can include first cantilevers 210, second cantilevers 220, a reflection portion 230, connector portions 240, and support portions 250.

The reflection portion 230 can be formed as a micromirror, and light received from a light source may proceed after being reflected at the reflection portion 230. In this way, the reflection portion 230 can reflect incident light and alter the direction of the light. Here, the direction of the reflected light may differ according to the degree to which the reflection portion 230 is tilted. That is, the light entering the reflection portion 230 may proceed in observance of Snell's law of reflection, and the incident angle of the light may differ according to the degree to which the reflection portion 230 is tilted, and therefore the direction of the incident light may be altered. Using this principle, the tilt mirror 200 can adjust the direction in which the light proceeds.

According to an embodiment of the invention, one surface of the reflection portion 230 can be formed by way of a low-reflective coating (e.g. black coating, etc.). The one surface of the reflection portion 230 corresponds to the surface that receives the light from the light source, and it is to be appreciated that any subsequent reference to one surface of the reflection portion 230 is to have the meaning described above. Using the low-reflective coating, the reflectivity of the reflection portion 230 can be decreased, and the degree to which the light received by the reflection portion 230 is reflected and emitted can be lowered. A tilt mirror that includes a reflection portion 230 having such a low-reflective coating can be effectively utilized in an optical modulator. The tilt mirror applied to an optical modulator can alter the direction of the incident light and prevent unnecessary portions from being displayed on the image, and with the reflection portion 230 having a low-reflective coating to reduce the reflection of light itself, the tilt mirror may more effectively prevent the displaying of unnecessary images.

According to an embodiment of the invention, the first cantilevers 210 and the second cantilevers 220 can be operated to adjust the direction of light, which depends on the tilt of the reflection portion 230. The first cantilevers 210 and second cantilevers 220 can be formed on both ends of the reflection portion 230. That is, the first cantilevers 210 can each extend lengthwise from either end part of the reflection portion 230, while the second cantilevers 220 can each extend in the same direction as a respective first cantilever 210 directly beside the first cantilever 210. In the example illustrated in FIG. 2, cantilevers 210, 220 are formed extending from the longitudinal ends of the reflection portion 230 on both sides.

As illustrated in FIG. 2, the first cantilevers 210 may be formed on both longitudinal ends of the reflection portion 230 on the upper portions, while the second cantilevers 220 may be formed on both longitudinal ends of the reflection portion 230 on the lower portions. While it is possible to form just one first cantilever 210 and one second cantilever 220 each for one surface of the reflection portion 230, it is apparent to those skilled in the art that the numbers of first cantilevers 210 and second cantilevers 220 formed on the reflection portion 230 are not limited to the example illustrated in FIG. 2, and that the numbers may vary without departing from the spirit and scope of the invention.

The first cantilever 210 and the second cantilever 220 may each have one end connected with a connector portion 240, for connecting to the reflection portion 230, and may each have the other end, i.e. the end portion on the opposite side, supported by a support portion 250. The connector portion 240 can transfer the stresses created by the first and second cantilevers 210, 220 to the reflection portion 230.

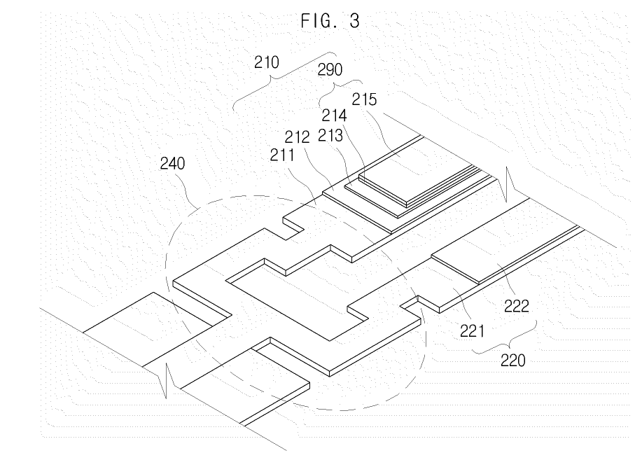

The first cantilever 210 and the second cantilever 220 may each be structured to include several thin films stacked together. Also, at least one of the first cantilever 210 and the second cantilever 220 can include an actuator, which may serve to modify the magnitude of the stresses created by the first and second cantilevers 210, 220. The structures of these elements will be described later in further detail with reference to FIG. 3.

A first cantilever 210 may generate a stress in one direction, while a second cantilever 220 may generate a stress in the other direction. Here, the stresses generated may be residual stresses. To be more specific, the stress in the one direction can be a tensile stress, while the stress in the other direction can be a compressive stress.

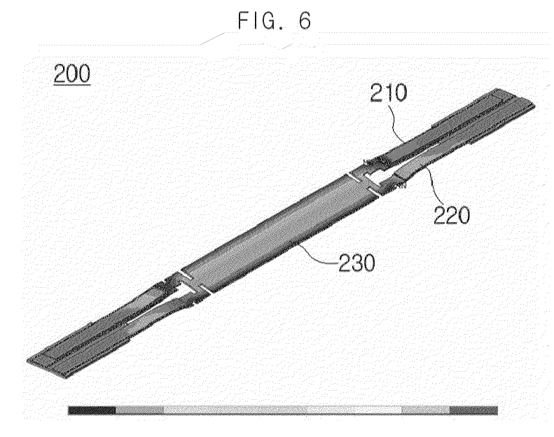

The tensile stress can be used by the first cantilever 210 to lift up the reflection portion 230. Conversely, the compressive stress generated by the second cantilever 220 can be used to push the reflection portion 230 downwards, i.e. in a vertical direction towards the ground from the initial position of the reflection portion 230. Thus, according to an embodiment of the invention, the stresses created in the first cantilevers 210 and the stresses created in the second cantilevers 220 can be in opposite directions of up and down. As the first cantilevers 210 and the second cantilever 220, which are connected by connector portions 240 to a single reflection portion 230, generate stresses in opposite directions, the reflection portion 230 may be tilted. This may readily be seen from the diagram of a tilt mirror as illustrated in FIG. 6. The tilt mirror illustrated in FIG. 6 has the reflection portion 230 tilted by residual stresses.

Here, it is sufficient that the stresses generated in one direction by the first cantilevers 210 and the stresses generated in the other direction by the second cantilevers 220 be in opposite directions, and the stresses do not necessarily have to be tensile or compressive stresses.

Also, at least one of the first cantilevers 210 and second cantilevers 220 may include an actuator, where a cantilever including such an actuator may modify the magnitude of the stress generated. As described above, if the stress in the one or the other direction is a residual stress, the magnitude of the residual stress in a cantilever that includes an actuator can be controlled by way of the actuator.

As described above, the stresses generated by the first and second cantilevers 210, 220 can be used to tilt the reflection portion 230 from an initial position (A) of the reflection portion 230 to an angle greater than or equal to a minimum of 0.5 degrees (B) and smaller than or equal to a maximum of 10 degrees (C).

A description will be provided as follows, with reference to FIG. 3, on the structure of a first cantilever 210 and a second cantilever 220 according to an embodiment of the invention. FIG. 3 is a diagram illustrating the structures of the first and second cantilevers on a tilt mirror according to an embodiment of the invention. As described above, the first cantilever 210 and the second cantilever 220 can generate stresses in opposite directions upwards and downwards to tilt the reflection portion 230.

While each cantilever 210, 220 can be formed to have a variety of structures, a cantilever based on one embodiment of the invention can be structured to have various thin films stacked over one another. A first cantilever 210, which may generate a tensile stress, may be formed from thin film layers of SiNₓ 211, silicon dioxide (SiO₂) 212, platinum (Pt) 213, PZT 214, and platinum (Pt) 215, stacked in order. A second cantilever 220, which may generate a compressive stress, may be formed from thin film layers of SiNₓ 221 and silicon dioxide (SiO₂) 222, deposited in order. As described above, the sequentially deposited thin films may generate stresses, i.e. residual stresses, to tilt the reflection portion 230. The tilted reflection portion 230 can be used to alter the direction of incident light.

Here, at least one of the first cantilever 210 and the second cantilever 220 can include an actuator 290, which can adjust the degree to which the cantilevers 210, 220 may be tilted. In the example illustrated in FIG. 3, the first cantilever 210 of the tilt mirror includes the actuator 290. The actuator 290 may include two electrodes 213, 215, as well as a piezoelectric layer 214 positioned between the two electrodes that is formed from a piezoelectric material to contract or expand according to the driving voltage delivered to the electrodes.

In this particular embodiment, the two electrodes 213, 215 can be made from platinum, and the piezoelectric layer 214 can be made from PZT. According to the voltage applied to the electrodes 213, 215, the piezoelectric layer 214 may contract or expand, whereby the magnitude of the stress generated in the first cantilever 210 may be modified, and the degree to which the cantilevers 210, 220 are tilted may be adjusted. While this embodiment has been described using an example in which an actuator is formed on the first cantilever 210, it is apparent to those skilled in the art that the actuator may also be formed on the second cantilever 220. Furthermore, the magnitude of the stresses generated in the cantilevers may also be controlled by applying an electric current, rather than a voltage, to the electrodes 213, 215.

As described above, it is possible to adjust the degree to which the reflection portion 230 is tilted by adjusting the voltage or current value applied to the actuator 290. By controlling the value of the electric voltage or current applied to the actuator 290, the magnitude of the stresses generated in the cantilevers 210, 220 can be controlled, which may in turn be used to adjust the degree to which the reflection portion 230 is tilted. Since the incident angle of light may vary according to the degree to which the reflection portion 230 is tilted, as described above, the path of the emitted light may also be changed, making it possible to control the direction of light.

The first cantilevers 210 and the second cantilevers 220 of a tilt mirror based on an embodiment of the invention can be formed as stacks of a variety of thin films, without departing from the spirit or scope of the invention, if they are capable of creating tensile and compressive stresses. The actuator 290 may also be made from a variety of materials that may serve as the electrodes and piezoelectric layer, without departing from the spirit or scope of the invention.

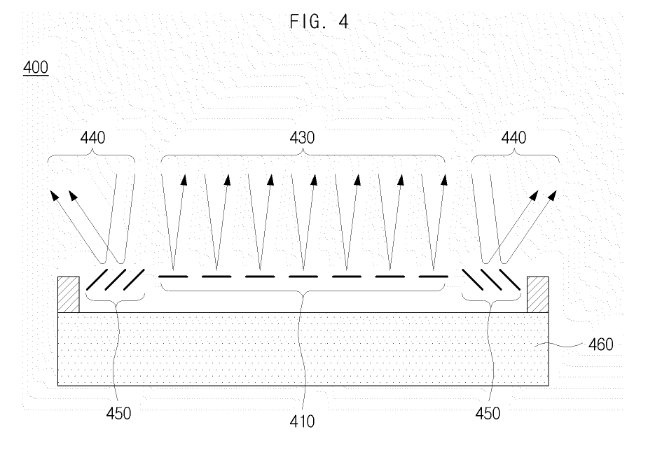

A description will be provided as follows, with reference to FIG. 4, on the structure of an optical modulator according to an embodiment of the invention. FIG. 4 is a diagram illustrating the structure of an optical modulator according to an embodiment of the invention.

An optical modulator 400 according to an embodiment of the invention can include a substrate 460, a multiple number of micromirrors 410, and a multiple number of tilt mirrors 450. As described above, the optical modulator 400 may modulate incident light and output it as modulated light. Light received by the micromirrors 410, which may be formed with a particular distance from the substrate 460, can be modulated and outputted as modulated light 430, to display an image on a screen. The multiple micromirrors 410 may be operated according to the voltage delivered, to output the incident light as modulated light 430.

On the other hand, light received by the tilt mirrors 450 formed in the dummy areas, which are the portions not needed in forming an image, may be outputted as spill light 440. In the case of a conventional optical modulator, the light entering the micromirrors formed in the actual area, which is the portion needed for forming an image, can form an image on the screen, but the light entering the dummy areas may form unwanted strips above and below the image, as described above. In the case of an optical modulator 400 based on an embodiment of the invention, however, a multiple number of tilt mirrors 450 can be formed in the dummy areas, to alter the direction of the received light, so that spill light 440 can be prevented from proceeding towards the screen and forming unwanted strips above and below the image.

As described above, the tilt mirrors 450 can be tilted from the initial positions to angles within range defined by a minimum of 0.5 degrees and a maximum of 10 degrees. A tilt mirror 450 may have to be tilted by an angle of at least 0.5 degrees from the initial position, if the spill light 440 entering and leaving the tilt mirror is not to proceed to the screen. In other words, the minimum angle of the tilt mirror 450 that does not cause unwanted strips above or below the image may be about 0.5 degrees. Conversely, if the tilt mirror 450 is tilted by more than 10 degrees from the initial position, the space required by the tilt mirrors 450 may be increased, imposing a limit to application in miniaturized optical modulators. As such, the maximum angle which the tilt mirrors 450 may implement can be set to 10 degrees.

By thus forming tilt mirrors 450 in the dummy areas to alter the direction of light received by the tilt mirrors 450, an optical modulator 400 according to this embodiment can resolve the problem in conventional optical modulators of having unwanted strips formed above and below the image.

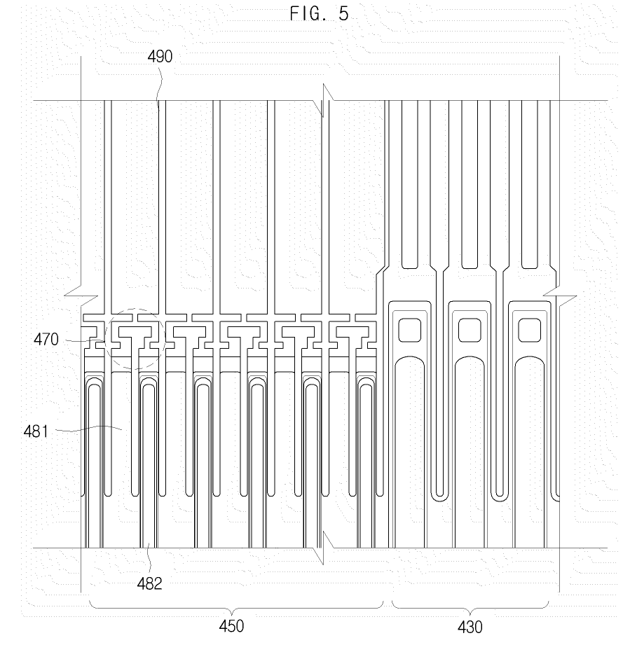

A description will be provided as follows, with reference to FIG. 5, on the structure of an optical modulator according to an embodiment of the invention. FIG. 5 is a plan view of an optical modulator according to an embodiment of the invention.

An optical modulator according to an embodiment of the invention can include a multiple number of micromirrors 410 and a multiple number of tilt mirrors 450. Here, the tilt mirrors 450 may include first cantilevers 481, second cantilevers 482, connector portions 470, and reflection portions 490, as already described above. The stresses generated in the first cantilevers 481 and the second cantilevers 482 can tilt the reflection portions 490 to particular angles, so that the light received by the tilt mirrors 450 may not proceed towards the screen. In addition to preventing the light entering the dummy areas from moving towards the screen, using the tilting of the reflection portions 490, so that noise in the image may be removed, a low-reflective coating may also be applied to the surfaces of the reflection portions 490. By applying a low-reflective coating to the surfaces of the reflection portions 490 that receive light from the light source, the amount of light emitted from the dummy areas may be reduced, and the noise in the image can be removed. That is, by applying a low-reflective coating to the surfaces of the reflection portions 490, the removing of noise from an image using tilt mirrors 450 can be maximized in effectiveness. Here, the low-reflective coating material can be any material that has a lower reflectivity than does the material used for the micromirrors 410.

As set forth above, certain embodiments of the invention provide a simple composition that can be utilized to alter the path for rays of light.

Also, according to certain embodiments of the invention, unwanted noise can be removed from images formed by an optical modulator.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

Many embodiments other than those set forth above can be found in the appended claims.

1. A tilt mirror comprising:
a reflection portion configured to reflect incident light;
a first cantilever formed on either end of the reflection portion and configured to generate a stress in one direction;
a second cantilever formed on either end of the reflection portion beside the first cantilever and configured to generate a stress in the other direction; and
a connector portion connecting the reflection portion with one end of the first cantilever and connecting the reflection portion with one end of the second cantilever such that the stress generated in the one direction and the stress generated in the other direction are transferred to the reflection portion.

2. The tilt mirror of claim 1, further comprising:
a support portion supporting the other end of the first cantilever and the other end of the second cantilever.

3. The tilt mirror of claim 1, wherein the stress in the one direction is tensile stress and the stress in the other direction is compressive stress.

4. The tilt mirror of claim 1, wherein at least one of the first cantilever and the second cantilever comprises an actuator configured to modify a magnitude of the stress.

5. The tilt mirror of claim 4, wherein the actuator comprises:
two electrodes; and
a piezoelectric layer interposed between the two electrodes, the piezoelectric layer made from a piezoelectric material and configured to contract or expand according to an operating voltage delivered to the two electrodes.

6. The tilt mirror of claim 1, wherein the first cantilever is a structure comprising SiNₓ, silicon dioxide (SiO₂), platinum (Pt), PZT, and platinum (Pt) stacked in order.

7. The tilt mirror of claim 1, wherein the second cantilever is a structure comprising SiNₓ and silicon dioxide (SiO₂) stacked in order.

8. The tilt mirror of claim 1, wherein one surface of the reflection portion has a low-reflective coating applied thereto,
the one surface of the reflection portion being a surface receiving incident light from a light source.

9. The tilt mirror of claim 1, wherein the reflection portion is configured to tilt from an initial position by an angle greater than or equal to 0.5 degrees and smaller than or equal to 10 degrees.

10. An optical modulator comprising:
a substrate;
a plurality of ribbons formed in an actual area of the substrate and separated from the substrate by a predetermined distance, the ribbons operated in accordance to a delivered voltage and configured to modulate and output incident light received from a light source; and
a plurality of tilt mirrors formed in a dummy area of the substrate,
wherein the tilt mirror comprises:
a reflection portion configured to reflect incident light;
a first cantilever formed on either end of the reflection portion and configured to generate a stress in one direction;
a second cantilever formed on either end of the reflection portion beside the first cantilever and configured to generate a stress in the other direction; and
a connector portion connecting the reflection portion with one end of the first cantilever and connecting the reflection portion with one end of the second cantilever such that the stress generated in the one direction and the stress generated in the other direction are transferred to the reflection portion,
and wherein the actual area is an area needed for forming an image, and the dummy area is an area not needed for forming an image.

11. The optical modulator of claim 10, further comprising:
a support portion supporting the other end of the first cantilever and the other end of the second cantilever.

12. The optical modulator of claim 10, wherein the stress in the one direction is a tensile stress and the stress in the other direction is a compressive stress.

13. The optical modulator of claim 10, wherein at least one of the first cantilever and the second cantilever comprises an actuator configured to modify a magnitude of the stress.

14. The optical modulator of claim 13, wherein the actuator comprises:
two electrodes; and
a piezoelectric layer interposed between the two electrodes, the piezoelectric layer made from a piezoelectric material and configured to contract or expand according to an operating voltage delivered to the two electrodes.

15. The optical modulator of claim 10, wherein the first cantilever is a structure comprising SiNₓ, silicon dioxide (SiO₂), platinum (Pt), PZT, and platinum (Pt) stacked in order.

16. The optical modulator of claim 10, wherein the second cantilever is a structure comprising SiNₓ and silicon dioxide (SiO₂) stacked in order.

17. The optical modulator of claim 10, wherein one surface of the reflection portion has a low-reflective coating applied thereto,
the one surface of the reflection portion being a surface receiving incident light from the light source.

18. The optical modulator of claim 10, wherein the reflection portion is configured to tilt from an initial position by an angle greater than or equal to 0.5 degrees and smaller than or equal to 10 degrees.
